(19) United States
(12) Patent Application Publication
(10) Pub. No.: US 2023/0148314 A1
(43) Pub. Date: May 11, 2023

(54) Fast Launch Based on Hibernated Pre-launch Sessions

(71) Applicant: Citrix Systems, Inc., Fort Lauderdale, FL (US)

(72) Inventor: Manbinder Pal Singh, Coral Springs, FL (US)

(21) Appl. No.: 17/524,171

(22) Filed: Nov. 11, 2021

(51) Int. Cl. G06F 9/455

(52) U.S. Cl. CPC G06F 9/45558; G06F 2009/4557; G06F 2009/45562; G06F 2009/45575

(57) ABSTRACT

Methods and systems for launching sessions within virtual machine instances using hibernated pre-launch sessions are described herein. A controller may compare a number of pre-launch sessions needed at a first time to a number of available pre-launch sessions. Based on the number of pre-launch sessions needed at the first time exceeding the number of available pre-launch sessions, the controller may generate and hibernate additional pre-launch sessions. The controller may compare the number of pre-launch sessions needed at the first time to a number of pre-launch sessions needed at a second time. Based on the number of pre-launch sessions needed at the first time exceeding the number of pre-launch sessions needed at the second time, the controller may delete pre-launch sessions. Based on the number of pre-launch sessions needed at the second time exceeding the number of pre-launch sessions needed at the first time, the controller may hibernate pre-launch sessions.

### FIELD

Aspects described herein generally relate to computer networking, remote computer access, virtualization, and hardware and software related thereto. More specifically, one or more aspects described herein provide systems and methods for launching a session within a virtual machine instance using hibernated pre-launch sessions.

### BACKGROUND

Users may utilize virtual computing environments to run computer programs and computer services on remote servers as opposed to running the computer programs and computer services on physical, local machines. To access a virtual computing environment, a user may connect to a session that is hosted by a virtual machine on a virtualization server. Launching sessions to access a virtual computing environment requires the virtual machine to generate pre-launch sessions prior to receiving user requests for access to a virtual computing environment. If the number of user requests exceeds the number of available pre-launch sessions, the virtual machine generates additional pre-launch sessions to satisfy the demand for access to a virtual computing environment. However, the quality of the user experience diminishes during the time that the virtual machine takes to generate additional pre-launch sessions since users are unable to connect to a virtual computing environment upon request. While a virtual machine may generate a surplus of pre-launch sessions prior to receiving user requests for access to a virtual computing environment, the cost of hosting the surplus of pre-launch sessions increases as the number of pre-launch sessions within the surplus increases.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Since generating an additional pre-launch session after receiving a user request for access to a virtual computing environment may diminish the quality of the user experience, a virtual machine, hosted on a virtualization server, may use hibernated pre-launch sessions to satisfy user requests. A session predictor, or a prediction model, within a virtual machine may predict the number of pre-launch sessions that may be needed at a first time. A controller may compare the predicted number of pre-launch sessions that may be needed at the first time to a number of available pre-launch sessions. Based on the predicted number of pre-launch sessions needed at the first time exceeding the number of available pre-launch sessions, the controller may generate and hibernate additional pre-launch sessions. The additional pre-launch sessions may remain in a hibernated state until the virtual machine moves the additional pre-launch sessions from a hibernated state to a running state to satisfy a user request for access to a virtual computing environment.

Alternatively, based on the number of available pre-launch sessions exceeding the predicted number of pre-launch sessions needed at the first time, the session predictor, or the prediction model, may predict the number of pre-launch sessions that may be needed at a second time. The controller may compare the predicted number of pre-launch sessions needed at the first time to the predicted number of pre-launch sessions needed at the second time. Based on the predicted number of pre-launch sessions needed at the first time exceeding the predicted number of pre-launch sessions needed at the second time, the controller may delete excess pre-launch sessions. Alternatively, based on the predicted number of pre-launch sessions needed at the second time exceeding the predicted number of pre-launch sessions needed at the first time, the controller may hibernate excess pre-launch sessions that might not be needed until the second time.

Launching a session to access a virtual computing environment using a hibernated pre-launch session may be more efficient than generating an additional pre-launch session. As such, the use of hibernated pre-launch sessions may reduce the amount of time that a user may wait to be connected to a virtual computing environment. Since hibernated pre-launch sessions do not consume network resources until the pre-launch sessions are used to connect a user to a virtual computing environment, a hibernated pre-launch session might not consume network resources until the hibernated pre-launch session moves from the hibernated state to the running state. As such, the cost of hosting hibernated pre-launch sessions might not increase as the number of hibernated pre-launch sessions increases.

To overcome limitations described above, and to overcome other limitations that will be apparent upon reading and understanding the present specification, aspects described herein are directed towards systems and methods for launching a session within a virtual machine instance using hibernated pre-launch sessions. A session predictor and a prediction model may predict the number of pre-launch sessions that may be needed at a first time. A pre-launch controller may determine the number of available pre-launch sessions. The pre-launch controller may compare the number of available pre-launch sessions to the predicted number of pre-launch sessions that may be needed at the first time. The pre-launch controller may determine that the predicted number of pre-launch sessions that may be needed at the first time exceeds the number of available pre-launch sessions. The pre-launch controller may determine the number of additional pre-launch sessions that may be needed to match the predicted number of pre-launch sessions that may be needed at the first time. The pre-launch controller may instruct the hibernation controller to generate a number of additional pre-launch sessions to match the predicted number of pre-launch sessions that may be needed at the first time. The hibernation controller may generate and hibernate the additional pre-launch sessions. Alternatively, the pre-launch controller may determine that the number of available pre-launch sessions exceeds the predicted number of pre-launch sessions that may be needed at the first time. The session predictor and the prediction model may predict the number of pre-launch sessions that may be needed at a second time. The pre-launch controller may compare the predicted number of pre-launch sessions that may be needed at the first time to the predicted number of pre-launch sessions that may be needed at the second time. Based on the predicted number of pre-launch sessions that may be needed at the first time exceeding the predicted number of pre-launch sessions that may be needed at the second time, the pre-launch controller may determine the number of excess pre-launch sessions that might not be needed at the second time. The pre-launch controller may instruct the hibernation controller to delete the excess pre-launch sessions. Based on the predicted number of pre-launch sessions that may be needed at the second time exceeding the predicted number of pre-launch sessions that may be needed at the first time, the pre-launch controller may determine the excess pre-launch sessions that might not be needed at the first time. The pre-launch controller may instruct the hibernation controller to hibernate the excess pre-launch sessions until they are needed at the second time.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used to launch a session within a virtual machine instance using hibernated pre-launch sessions in accordance with one or more illustrative aspects described herein.

FIG. 2 depicts an illustrative remote-access system architecture that may be used to launch a session within a virtual machine instance using hibernated pre-launch sessions in accordance with one or more illustrative aspects described herein.

FIG. 3 depicts an illustrative virtualized system architecture that may be used to launch a session within a virtual machine instance using hibernated pre-launch sessions in accordance with one or more illustrative aspects described herein.

FIG. 4 depicts a desktop and application virtualization system diagram illustrating various components and modules that can be used to launch a session within a virtual machine instance using hibernated pre-launch sessions in accordance with one or more illustrative aspects described herein.

FIGS. 5A-5C depict an illustrative cloud-based architecture in which hibernated pre-launch sessions are used to launch a session within a virtual machine instance using hibernated pre-launch sessions in accordance with one or more illustrative aspects described herein.

FIG. 6A depicts a client device and server system diagram illustrating various components and modules that can be used to launch a session within a virtual machine instance using hibernated pre-launch sessions in accordance with one or more illustrative aspects described herein.

FIG. 6B depicts an illustrative virtual machine instance wherein hibernated pre-launch sessions can be used to launch a session in accordance with one or more illustrative aspects described herein.

FIG. 6C depicts an illustrative hibernation process that can be used to launch a session within a virtual machine instance using hibernated pre-launch sessions in accordance with one or more illustrative aspects described herein.

FIG. 7 depicts an illustrative method for launching a session within a virtual machine instance using hibernated pre-launch sessions in accordance with one or more illustrative aspects described herein.

FIG. 8 depicts illustrative prediction data that can be used for launching a session within a virtual machine instance using hibernated pre-launch sessions in accordance with one or more illustrative aspects described herein.

FIG. 9 depicts illustrative pre-launch session availability data that can be used for launching a session within a virtual machine instance using hibernated pre-launch sessions in accordance with one or more illustrative aspects described herein.

FIG. 10 depicts illustrative deletion data that can be used for launching a session within a virtual machine instance using hibernated pre-launch sessions in accordance with one or more illustrative aspects described herein.

FIG. 11 depicts illustrative hibernation data that can be used for launching a session within a virtual machine instance using hibernated pre-launch sessions in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” “engaged” and similar terms, is meant to include both direct and indirect connecting, coupling, and engaging.

As a general introduction to the subject matter discussed herein, methods and systems are described for launching a session within a virtual machine instance using hibernated pre-launch sessions. A virtual machine instance may host a plurality of pre-launch sessions, wherein each pre-launch session may connect a user to a virtual computing environment. The pre-launch sessions within the virtual machine instance may remain in a hibernated state until the virtual machine instance receives a user request to access a virtual computing environment. Upon receipt of a request, the virtual machine instance may launch a pre-launch session, providing the user with a virtual computing environment. The methods and systems described herein may be used to determine the number of available pre-launch sessions and to predict the number of pre-launch sessions that may be needed at some time in the future. The methods and systems described herein may be used to generate additional pre-launch sessions and to hibernate the additional pre-launch sessions until the additional pre-launch sessions are needed at some time in the future. These and additional details are described more fully below.

### Computing Architecture

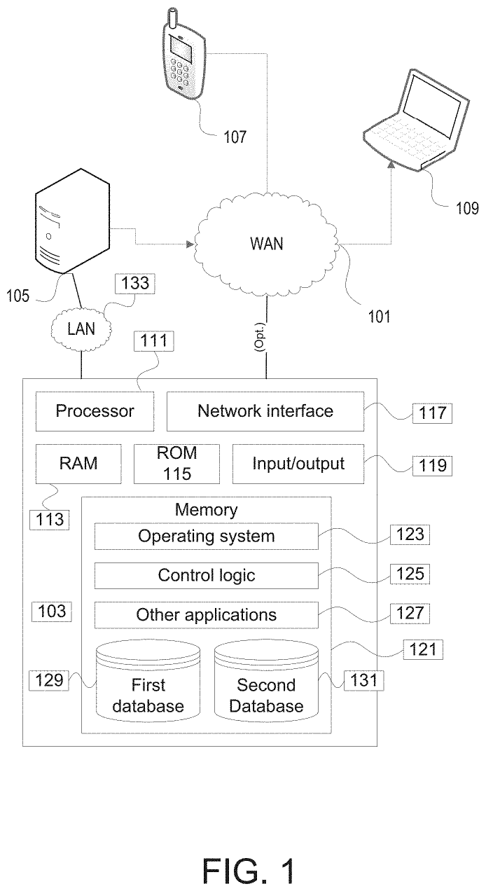

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

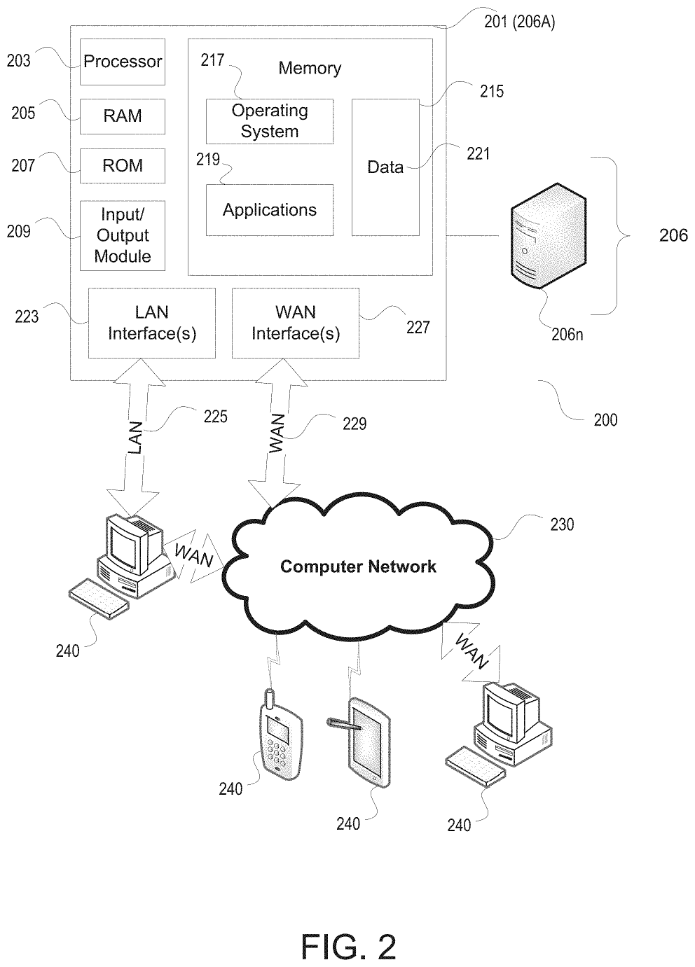

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

1/0 module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment, a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an output window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network

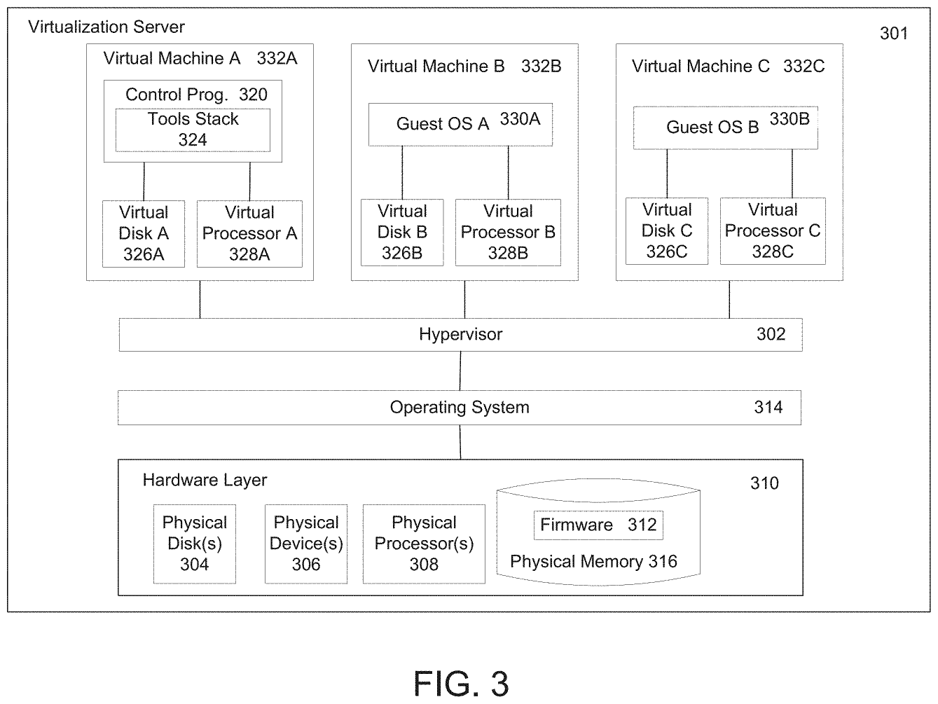

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e g , many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, DomO, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing component. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same parameters of at least one physical processor 308. In other embodiments, virtual processor 308 provides a modified view of physical processors 308 such that at least some of the parameters of the virtual processor 328 are different than the parameters of the corresponding physical processor 308.

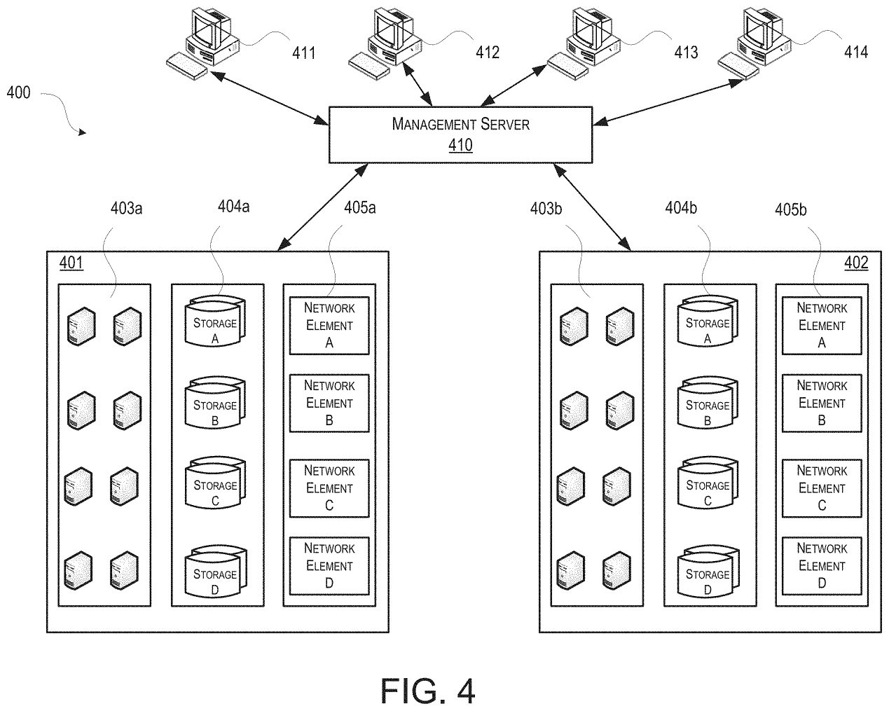

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

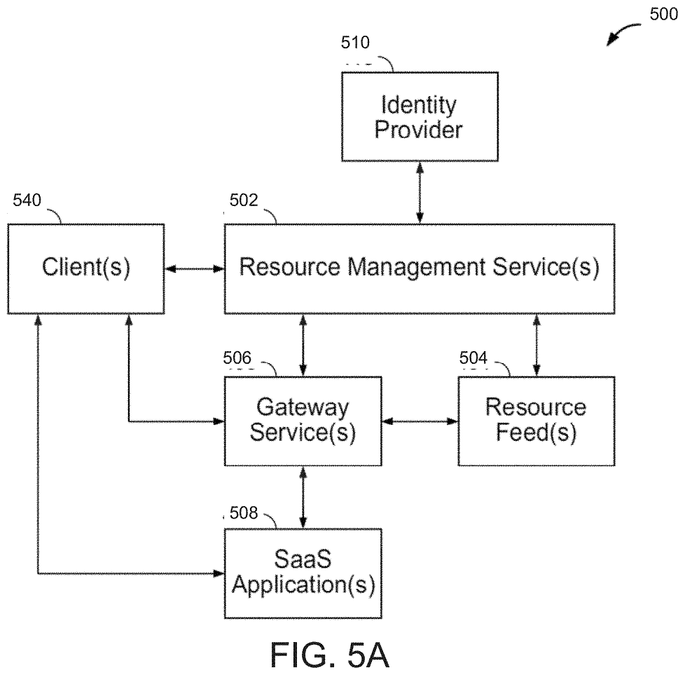

FIG. 5A is a block diagram of an example multi-resource access system 500 in which one or more resource management services 502 may manage and streamline access by one or more clients 540 (e.g., desktop computers) to one or more resource feeds 504 (via one or more gateway services 506) and/or one or more software-as-a-service (SaaS) applications 508. In particular, the resource management service(s) 502 may employ an identity provider 510 to authenticate the identity of a user of a client 540 and, following authentication, identify one of more resources the user is authorized to access. In response to the user selecting one of the identified resources, the resource management service(s) 502 may send appropriate access credentials to the requesting client 540, and the client 540 may then use those credentials to access the selected resource. For the resource feed(s) 504, the client 540 may use the supplied credentials to access the selected resource via a gateway service 506. For the SaaS application(s) 508, the client 540 may use the credentials to access the selected application directly.

The client(s) 540 may be any type of computing devices capable of accessing the resource feed(s) 504 and/or the SaaS application(s) 508, and may, for example, include a variety of desktop or laptop computers, mobile phones, tablets, etc. The resource feed(s) 504 may include any of numerous resource types and may be provided from any of numerous locations. In some embodiments, for example, the resource feed(s) 504 may include one or more systems or services for providing virtual computing environments to the client(s) 540, one or more file repositories and/or file sharing systems, one or more secure browser services, one or more access control services for the SaaS applications 508, one or more management services for local applications on the client(s) 540, one or more Internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 540) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 540 may use a resource access application 522 to communicate with the client interface service 514 as well as to present a user interface on the client 540 that a user 524 can operate to access the resource feed(s) 504 and/or the SaaS application(s) 508. The resource access application 522 may either be installed on the client 540, or may be executed by the client interface service 514 (or elsewhere in the multi-resource access system 500) and accessed using a web browser (not shown in FIG. 5B) on the client 540.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., username and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 540 to be redirected to the cloud-based identity service to complete an authentication process. The cloud-based identity service may then cause the client 540 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successful authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 540. The list of available resources may, for example, be presented on the user interface of the client 540 as a set of selectable icons or other elements corresponding to accessible resources. The resources so identified may, for example, include one or more file repositories and/or file sharing systems (e.g., Sharefile®), one or more secure browsers, one or more internet enabled devices or sensors, one or more local applications installed on the client 540, and/or one or more SaaS applications 508 to which the user 524 has subscribed. The lists of local applications and the SaaS applications 508 may, for example, be supplied by resource feeds 504 for respective services that manage which applications are to be made available to the user 524 via the resource access application 522. Examples of SaaS applications 508 that may be managed and accessed as described herein may include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 540 may proceed to access the selected resource.

When the user 524 selects a local application, the resource access application 522 may cause the selected local application to launch on the client 540. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 540 may then launch the identified browser and initiate a connection to the gateway service 506. The gateway service 506 may then request an assertion from the single sign-on service 520. Upon receiving the assertion, the gateway service 506 may cause the identified browser on the client 540 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 540 to access the selected SaaS application 508.

In some embodiments, the preferred browser identified by the gateway service 506 may be a specialized browser embedded in the resource access application 522 (when the resource access application 522 is installed on the client 540) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (4) restricting navigation, e.g., by disabling the next and/or back browser buttons, (5) restricting downloads, e.g., by disabling the ability to download from within the SaaS application, and (6) displaying watermarks, e.g., by overlaying a screen-based watermark showing the username and IP address associated with the client 540 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 540, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 540 to notify a user 524 of a message requesting user action (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 540. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI). Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically cause active data to be pulled from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resources being interacted with.

In some embodiments, the analytics service 536 may process the raw events received from the microapp service 528 to create targeted scored notifications and send such notifications to the notification service 538.

In some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 540 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 540 as a push notification to the user 524.

In some embodiments, a process for processing a user-initiated action via a microapp may operate as follows. The client 540 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow user 524 to work efficiently, stay organized, and request only the specific information they need.

### Fast Launch Based on Hibernated Pre-Launch Sessions

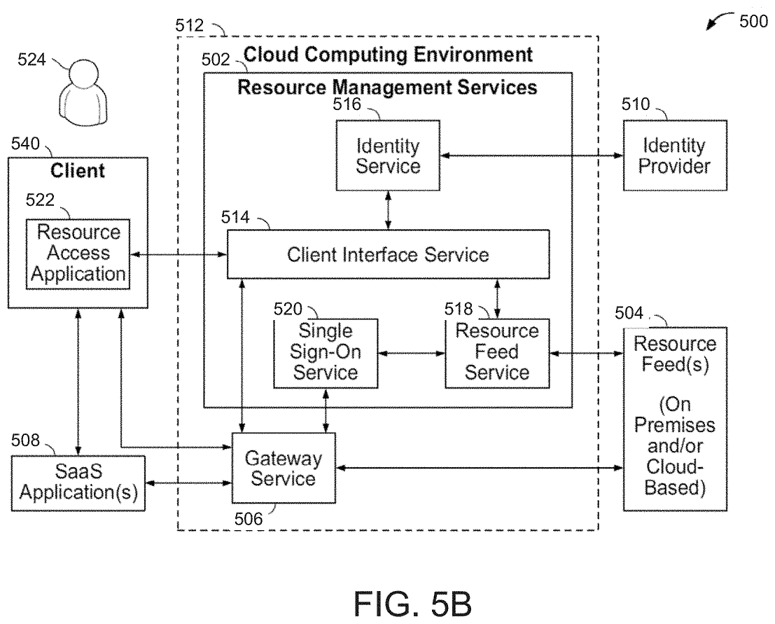

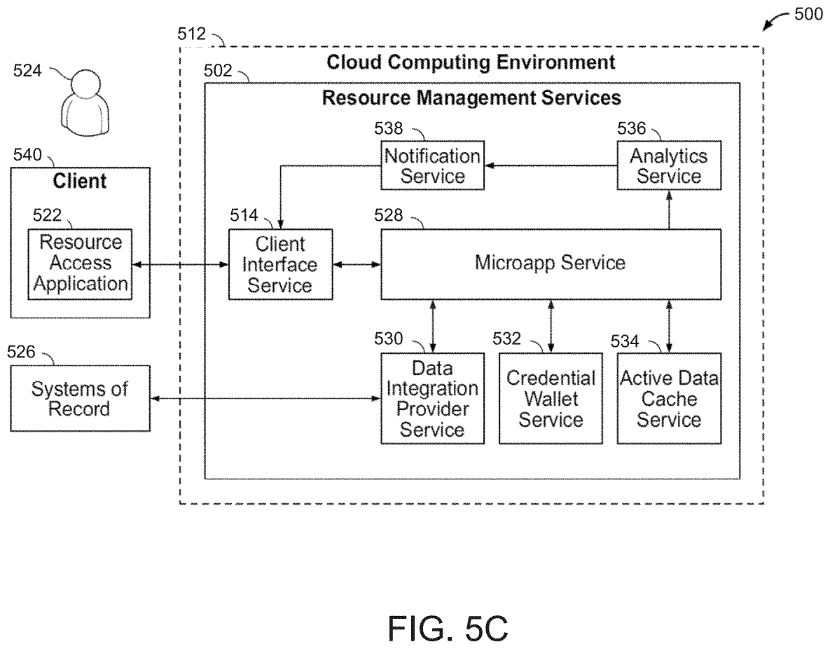

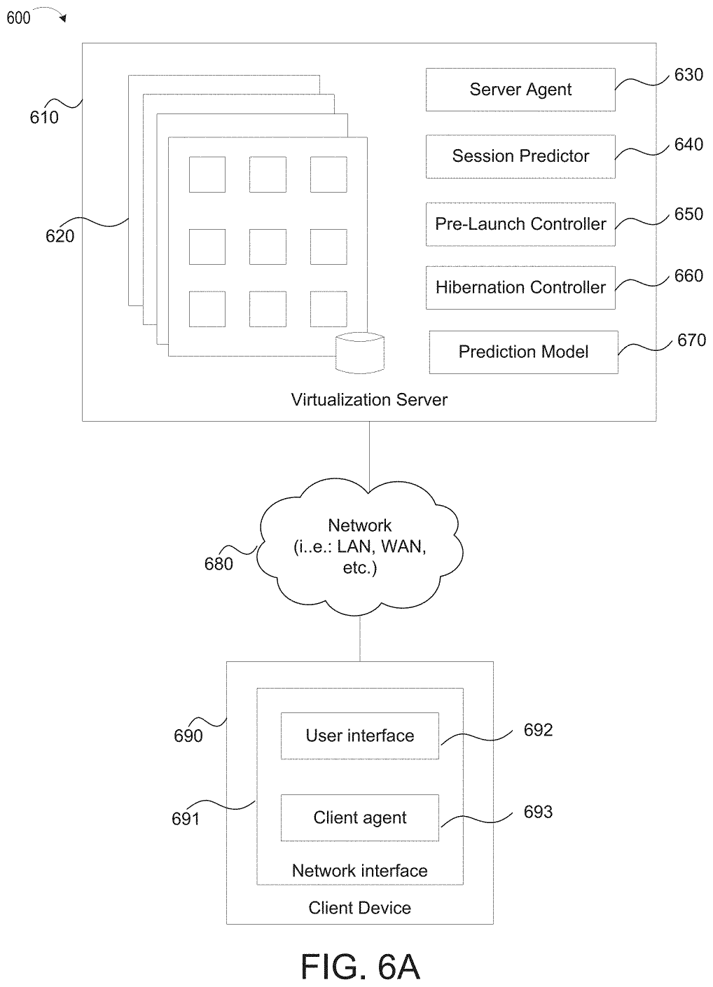

FIG. 6A illustrates an example of a system configuration including a virtualization server, a client device, and a network. In such embodiments, virtualization server 610 may include virtual machine instance 620, server agent 630, session predictor 640, pre-launch controller 650, hibernation controller 660, and prediction model 670. FIG. 6B illustrates an example of the virtual machine instances that may be used for launching a session using hibernated pre-launch sessions. As illustrated in FIG. 6B virtual machine instance 620 may comprise virtual machine instances 621-624. While four virtual machine instances are displayed in FIG. 6B (e.g., virtual machine instances 621-624), any number of virtual machine instances may exist within virtualization server 610. Each one of virtual machine instances 621-624 may perform the features discussed herein. As such, virtual machine instances 621-624 may be collectively referred to herein as virtual machine instance 620.

Virtual machine instance 620 may be a virtual workspace that permits users to remotely access computer applications and computer services. One example of virtual machine instance 620 may be Citrix Workspace, discussed in connection with FIGS. 5A-5C, developed by Citrix Systems, Inc. of Ft. Lauderdale, Fla. Virtual machine instance 620 may present, for interaction by a user, computer applications and computer services that traditionally run in physical computing environments. To provide a virtual computing environment for a user, virtual machine instance 620 may use pre-launch sessions 621a-621i. While nine pre-launch sessions are displayed in FIG. 6B, virtual machine instance 620 may host any number of pre-launch sessions. Each one of pre-launch sessions 621a-621i may perform the features discussed herein. As such, pre-launch sessions 621a-621i may be collectively referred to herein as pre-launch session 621.

Pre-launch session 621 may be used to connect a user to a virtual computing environment. Virtual machine instance 620 and pre-launch session 621 may remain in a hibernated state until virtual machine instance 620 receives a user request for access to a virtual computing environment. Upon receipt of a user request for access to a virtual computing environment, virtual machine instance 620 may move from a hibernated state to a running state. FIG. 6C illustrates an example of the hibernation process of a virtual machine instance. Virtual machine instance 620 may remain in the running state until the hibernation process is initiated. As illustrated in FIG. 6C, in the running state, the processes running within virtual machine instance 620 may be stored in RAM 626. Storing the running processes in RAM 626 may allow virtual machine instance 620 to efficiently recall the processes and applications that a user may request. When the hibernation process is initiated, virtual machine instance 620 may enter the stopping state.

In the stopping state, the processes and application that are stored in RAM 626 may be copied to storage 625 (e.g., encrypted root volume). Virtual machine instance 620 may enter the hibernation state when the processes and applications that were previously stored in RAM 626 are stored in storage 625. In the hibernation state, virtual machine instance 620 may shutdown or “sleep” until virtual machine instance 620 receives a user request for access to a virtual computing environment. In the hibernation state, pre-launch session 621 may shutdown or “sleep” until virtual machine instance 620 launches pre-launch session 621 to satisfy a user request for access to a virtual computing environment. When virtual machine instance 620 receives a user request for access to a virtual computing environment, virtual machine instance 620 may enter the running state. In the running state, the processes and applications that were previously stored in storage 625 may return to RAM 626 on virtual machine instance 620. Virtual machine instance 620 may access the processes and applications stored in RAM 626 to satisfy user requests within the virtual computing environment. Pre-launch session 621 may access the data stored in RAM 626 and may use the data stored in RAM 626 to provide the user with a virtual computing environment. Additional virtual machine instances and additional pre-launch sessions may be generated and hibernated, by hibernation controller 660, as the predicted demand for pre-launch sessions increases, as described herein. Alternatively, existing virtual machine instances and existing pre-launch sessions may be deleted, by hibernation controller 660, as the predicted demand for pre-launch sessions decreases, as described herein.

Returning to FIG. 6A, virtualization server 610 may include server agent 630. Virtual machine instance 620 may use server agent 630 to communicate with client device 690. In some embodiments, virtual machine instance 620 may receive, via server agent 630, a user request for access to a virtual computing environment. Server agent 630 may communicate with client device 690 using network 680.

Virtualization server 610 may include session predictor 640 and prediction model 670. Session predictor 640 and prediction model 670 may predict, at different times, the number of pre-launch sessions that may be needed to satisfy user requests for access to a virtual computing environment. Pre-launch controller 650 and hibernation controller 660 may use the predictions by session predictor 640 and prediction model 670 to determine whether additional virtual machine instances and additional pre-launch sessions may be needed at different times.

To predict the number of pre-launch sessions that may be needed, session predictor 640 may receive, from virtualization server 610, a plurality of times for which session predictor 640 may predict the number of pre-launch sessions that may be needed. For example, virtualization server 610 may instruct session predictor 640 to predict the number of pre-launch sessions that may be needed at 12:00 PM and at 2:00 PM. Virtualization server 610 may instruct session predictor 640 to predict the number of pre-launch sessions that may be needed at different times to determine whether to increase or decrease the number of available pre-launch sessions.

Virtualization server 610 may transmit prediction data to session predictor 640, which session predictor 640 may consider prior to predicting the number of pre-launch sessions that may be needed at different times. The prediction data may indicate the day(s) and the time(s) for which a prediction may be needed, previous predictions for the day(s) and time(s) indicated by virtualization server 610 (e.g., the number of pre-launch sessions that were predicted for use in recent days, weeks, months, and years), the number of pre-launch sessions that were previously used on the day(s) and at the time(s) indicated by virtualization server 610 (e.g., the number of pre-launch sessions that were used in recent days, weeks, months, years), and the like. For example, virtualization server 610 may instruct session predictor 640 to predict the number of pre-launch sessions that may be needed on Jan. 1, 2021 at 12:00 PM and at 2:00 PM. Session predictor 640 may use the prediction data indicating the number of pre-launch sessions that were previously used to inform the current prediction (e.g., the number of pre-launch sessions that were used on January 1 in recent years, the number of pre-launch sessions that were used on the first day of each month for the last six months, and the like). For example, the prediction data may indicate that the number of pre-launch sessions that were used at 12:00 PM on January 1 in recent years might not have exceeded 75 pre-launch sessions and that the number of pre-launch sessions that were used at 2:00 PM on January 1 in recent years might not have exceeded 50 pre-launch sessions. Session predictor 640 may generate at least two predictions for at least two different times selected by virtualization server 610, and may transmit the predictions to pre-launch controller 650.

Virtualization server 610 may also use the prediction data to train prediction model 670 (e.g., a time series forecasting model). Virtualization server 610 may transmit, to prediction model 670, the number of pre-launch sessions that were previously predicted for use on the day(s) and at the time(s) indicated by virtualization server 610 (e.g., the number of pre-launch sessions that were predicted for use in recent days, weeks, months, years). Virtualization server 610 may transmit, to prediction model 670, the number of pre-launch sessions that were previously used on the day(s) and at the time(s) indicated by virtualization server 610 (e.g., the number of pre-launch sessions that were used in recent days, weeks, months, years). Virtualization server 610 may transmit, to prediction model 670, the day(s) and the time(s) for which a prediction may be needed (e.g., input data).

Prediction model 670 may store the number of pre-launch sessions that were previously predicted for use on the day(s) and at the time(s) indicated by virtualization server 610 and the number of pre-launch sessions that were previously used on the day(s) and at the time(s) indicated by virtualization server 610, and may use this data as training data for future predictions. Prediction model 670 may accept, as input data from the virtualization server 610, the day(s) and the time(s) for which a prediction may be needed. Prediction model 670 may compare the input data to the training data. Prediction model 670 may determine whether the input data matches the training data (e.g., whether the training data contains the number of pre-launch sessions that were predicted for use on the same day and at the same time indicated by virtualization server 610). If the input data matches the training data, prediction model 670 may use the training data that matches the input data to predict the number of pre-launch sessions that may be needed on the day(s) and at the time(s) indicated by virtualization server 610.

Alternatively, if the input data does not match the training data, prediction model 670 may determine whether the input data is similar to the training data (e.g., whether the training data contains the number of pre-launch sessions that were predicted for use on the day indicated by virtualization server 610 but at a different time, whether the training data contains the number of pre-launch sessions that were predicted for use at the time indicated by virtualization server 610 but on a different day, whether the training data contains the number of pre-launch sessions that were used on the day indicated by virtualization server 610 but at a different time, whether the training data contains the number of pre-launch sessions that were used at the time indicated by virtualization server 610 but on a different day, or the like).

For example, the input data may indicate that virtualization server 610 requires a prediction for the number of pre-launch sessions that may be needed on Jan. 1, 2021 at 12:00 PM. Prediction model 670 may determine that the training data contains the number of pre-launch sessions that were previously predicted for use at 12:00 PM on January 1 (e.g., 71 to 75 pre-launch sessions) and the number of pre-launch sessions that were previously used at 12:00 PM on January 1 (e.g., 71 to 74 pre-launch sessions). Prediction model 670 may predict, based on the training data, that, at most, 75 pre-launch sessions may be needed at 12:00 PM on Jan. 1, 2021.

Alternatively, prediction model 670 may determine that the input data does not match the training data. For example, the input data may indicate that virtualization server 610 requires a prediction for the number of pre-launch sessions that may be needed at 2:00 PM on the first day of every month. Prediction model 670 may determine that the training data contains the number of pre-launch sessions that were previously predicted for use at 2:00 PM on January 1 (e.g., 46 to 50 pre-launch sessions) and the number of pre-launch sessions that were previously used at 2:00 PM on January 1 (e.g., 45 to 50 pre-launch sessions). Prediction model 670 may determine that the training data does not match the input data, but is similar to the input data (e.g., the training data does not contain the number of pre-launch sessions that were predicted for use at 2:00 PM on the first day of every month, but the training data contains the number of pre-launch sessions that were predicted for use at 2:00 PM on the first day of January). Prediction model 670 may use the training data to inform the current prediction. Since at most 50 pre-launch sessions were used at 2:00 PM on January 1, prediction model 670 may predict, based on the training data, that 50 pre-launch sessions may be needed on the first day of every month.

Prediction model 670 may add each prediction to the training data and may use the updated the training data to inform future predictions. Prediction model 670 may add the number of pre-launch sessions that were used to the training data and may use the updated training data to inform future predictions. The prediction model 670 may transmit each prediction to pre-launch controller 650.

Pre-launch controller 650 may receive, from either session predictor 640 or prediction model 670, each prediction for the number of pre-launch sessions needed on the day(s) and at the time(s) indicated by virtualization server 610. Pre-launch controller 650 may use a first prediction from either session predictor 640 or prediction model 670 to determine whether additional virtual machine instances and additional pre-launch sessions are needed to satisfy the prediction. Pre-launch controller 650 may determine the number of available virtual machine instances and the total number of available pre-launch sessions. Pre-launch controller 650 may compare the number of available pre-launch sessions to the predicted number of pre-launch sessions that may be needed at the first time. Pre-launch controller 650 may determine that additional pre-launch sessions are needed to satisfy the predicted number of pre-launch sessions that may be needed at the first time. Pre-launch controller 650 may notify hibernation controller 660 that additional pre-launch sessions are needed. Alternatively, pre-launch controller 650 may determine that the number of available pre-launch sessions satisfies the predicted number of pre-launch sessions that may be needed at the first time. As such, pre-launch controller 650 may determine, based on a second prediction from either session predictor 640 or prediction model 670, whether to hibernate or to delete any of the available pre-launch sessions. Pre-launch controller 650 may notify hibernation controller 660 that a number of the available pre-launch sessions may be hibernated or deleted.

Hibernation controller 660 may receive, from pre-launch controller 650, a notification indicating a number of additional pre-launch sessions that may be needed to satisfy the predicted number of pre-launch sessions that may be needed at the first time. Hibernation controller 660 may determine a number of additional virtual machine instances that may be needed to host the additional pre-launch sessions. Hibernation controller 660 may generate the additional virtual machine instances and the additional pre-launch sessions. Hibernation controller 660 may move the additional virtual machine instances and the additional pre-launch sessions to a hibernated state until the additional pre-launch sessions are needed at the first time. Alternatively, hibernation controller 660 may receive, from pre-launch controller 650, a notification indicating a number of available pre-launch sessions that may be hibernated or deleted. To hibernate the available pre-launch sessions, hibernation controller 660 may use the hibernation process described in FIG. 6C. To delete the available pre-launch sessions, hibernation controller 660 may identify the virtual machine instances that host the available pre-launch sessions to be deleted, and may delete the identified virtual machine instances.

The network connection depicted in FIG. 6A may include a local area network (LAN), a wide area network (WAN), or other networks. When used in a LAN networking environment, client device 690 may be connected to the LAN through a network interface or adapter. When used in a WAN networking environment, client device 690 may include a modem or other wide area network interface for establishing communications over the WAN. It will be appreciated that the network connections shown are illustrative and other means of establishing a communication link between the virtualization server 610 and client device 690 may be used.

Client device 690, as illustrated in FIG. 6A, may include network interface 691. Network interface 691 may connect client device 690 to network 680 such that client device 690 may communicate across network 680. Network interface 691 may include user interface 692 and client agent 693. Network interface 691 may communicate with server agent 630 within virtualization server 610. Client agent 693 may send, to server agent 630, a user request for access to a virtual computing environment. The user request may be processed within virtualization server 610. In some embodiments, the user may access the virtual computing environment using user interface 692. Server agent 630 and client agent 693 may use a remote presentation protocol to send and receive user requests for access to a virtual computing environment. Additionally, server agent 630 and client agent 693 may use a remote presentation protocol to display the virtual computing environment on client device 690. The remote protocol may be HDX protocol developed by Citrix Systems, Inc. of Ft. Lauderdale, Fla.

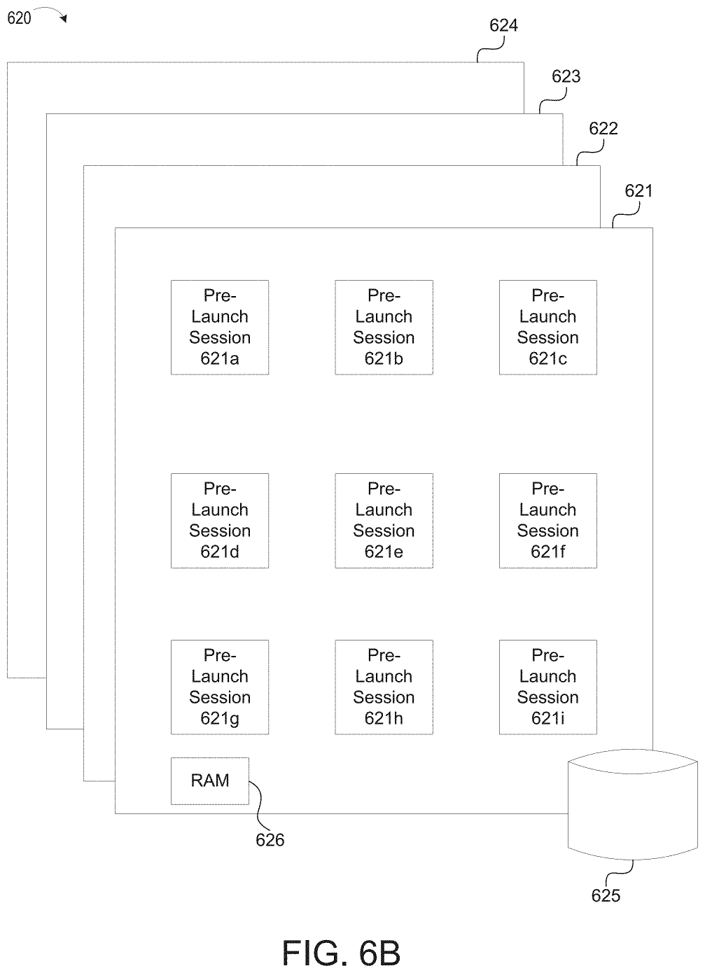

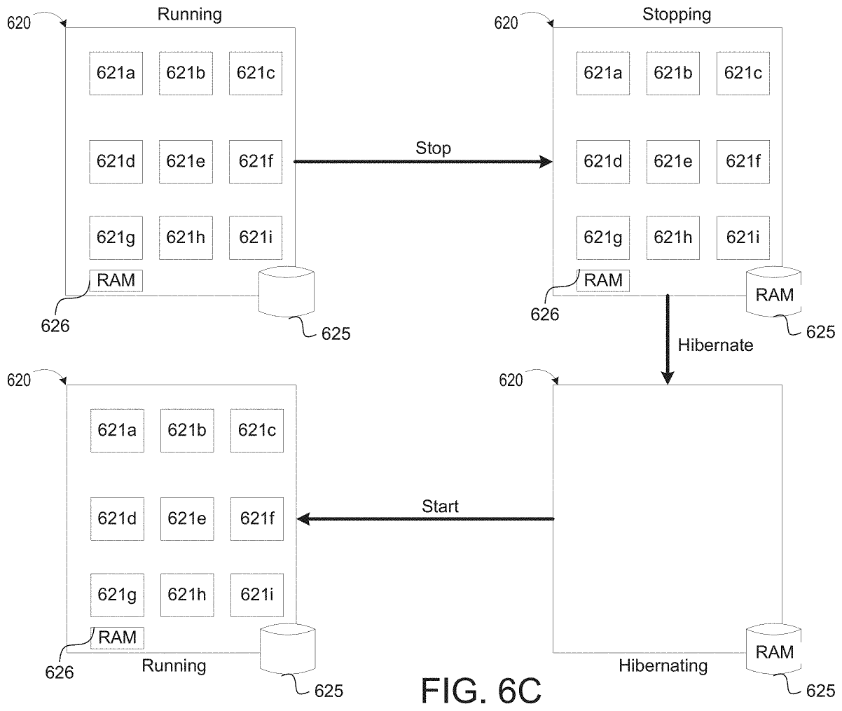

FIG. 7 illustrates a flow diagram of an example method for launching a session within a virtual machine instance using hibernated pre-launch sessions. The example method described in FIG. 7 is discussed in further detail in FIGS. 8-11. At step 705, session predictor 640 and prediction model 670 may predict the number of pre-launch sessions needed at a first time. To predict the number of pre-launch sessions needed at the first time, session predictor 640 and prediction model 670 may receive prediction data from virtualization server 610. FIG. 8 illustrates example prediction data that session predictor 640 and prediction model 670 may receive from virtualization server 610. As illustrated in FIG. 8, the prediction data from virtualization server 610 may indicate the date(s) upon which session predictor 640 and prediction model 670 may predict the number of pre-launch sessions that may be needed. For example, the prediction data may indicate that session predictor 640 and prediction model 670 should predict the number of pre-launch sessions that may be needed on Jan. 1, 2021. The prediction data may indicate the specific time(s) that session predictor 640 and prediction model 670 should predict the number of pre-launch sessions that may be needed. As illustrated in FIG. 8, the prediction data may indicate that session predictor 640 and prediction model 670 should predict the number of pre-launch sessions that may be needed at 12:00 PM on Jan. 1, 2021 and the number of pre-launch sessions that may be needed at 2:00 PM on Jan. 1, 2021. The prediction data may further indicate historical prediction data that session predictor 640 and prediction model 670 may use to predict the number of pre-launch sessions that may be needed. As illustrated in FIG. 8, the historical prediction data may indicate the number of pre-launch sessions that were predicted for use on the same day and at the same time in recent weeks, months, years, or the like (e.g., the number of pre-launch sessions that were predicted for use on a particular date over the last five years, the number of pre-launch sessions that were predicted for use on a particular day during each month over the last six months, and the like). For example, the historical prediction data may indicate that, in recent years, the number of pre-launch sessions that were predicted for use at 12:00 PM on January 1 ranged from 71 to 75 pre-launch sessions. The historical prediction data may also indicate that, in recent years, the number of pre-launch sessions that were predicted for use at 2:00 PM on January 1 ranged from 46 to 50 pre-launch sessions.

The prediction data may further indicate historical usage data that session predictor 640 and prediction model 670 may use to predict the number of pre-launch sessions that may be needed. As illustrated in FIG. 8, the historical usage data may indicate the number of pre-launch sessions that were used on the same day and at the same time in recent weeks, months, years, or the like (e.g., the number of pre-launch session that were used on a particular date over the last three years, the number of pre-launch sessions that were used on a particular day during each month over the last year, and the like). For example, the historical usage data may indicate that, in recent years, the number of pre-launch sessions that were used at 12:00 PM on January 1 ranged from 71 to 74 pre-launch sessions. The historical usage data may also indicate that, in recent years, the number of pre-launch sessions that were used at 2:00 PM on January 1 ranged from 45 to 50 pre-launch sessions.

Session predictor 640 and prediction model 670 may use the prediction data to determine the number of pre-launch sessions that may be needed on the day indicated by virtualization server 610 and at the first time indicated by virtualization server 610. Session predictor 640 and prediction model 670 may compare the date and time for which a prediction is needed to the historical prediction data and the historical usage data. If the date and time for which a prediction is needed matches the data within the historical prediction data or the historical usage data, session predictor 640 and prediction model 670 may use the data within the historical prediction data and the historical usage data to inform the present prediction. For example, since the number of pre-launch sessions that were predicted for use at 12:00 PM on January 1 in recent years did not exceed 75 pre-launch sessions and since the number of pre-launch sessions used at 12:00 PM on January 1 in recent years did not exceed 74 pre-launch sessions, session predictor 640 and prediction model 670 may predict that, at most, 75 pre-launch sessions may be needed at 12:00 PM on Jan. 1, 2021.

Alternatively, if the date and time for which a prediction is needed do not match the data within the historical prediction data or the historical usage data, session predictor 640 and prediction model 670 may locate alternate data (e.g., a combination of the same date and a different time, a combination of a different date and the same time, or the like). For example, the historical prediction data and historical usage data might not contain the number of pre-launch sessions that were predicted for use and the number of pre-launch sessions that were used on January 1 at 2:00 PM. Consequently, session predictor 640 and prediction model 670 may determine whether the historical prediction data and the historical usage data contains data for either a different date and the same time (e.g., the first day of February at 2:00 PM, the first day of September at 2:00 PM, or the like), or for the same date and a different time (e.g., January 1 at 12:00 PM, January 1 at 3:30 PM, or the like). If session predictor 640 and prediction model 670 determine that the historical prediction data and historical usage data do not match the date and time for which a prediction may be needed, session predictor 640 and prediction model 670 may use the alternate data to inform the current prediction.

Session predictor 640 and prediction model 670 may transmit the first prediction to pre-launch controller 650. Prediction model 670 may store the first prediction within the historical prediction data. Prediction model 670 may use the updated historical prediction data when making future predictions.

At step 710, pre-launch controller 650 may determine the number of pre-launch sessions that are currently available. To determine the number of available pre-launch sessions, pre-launch controller 650 may determine the number of available virtual machine instances within virtualization server 610. Virtual machine instance 620 may be available if virtual machine instance 620 contains available pre-launch sessions. Pre-launch session 621 may be available if pre-launch session 621 is not currently being used to present a virtual computing environment to client device 690 via user interface 692. Alternatively, virtual machine instance 620 may be unavailable if virtual machine instance 620 contains a pre-launch session that is currently being used to present a virtual computing environment to client device 690 via user interface 692. Pre-launch session 621 may be unavailable if pre-launch session 621 is being used to present a virtual computing environment to client device 690 via user interface 692.

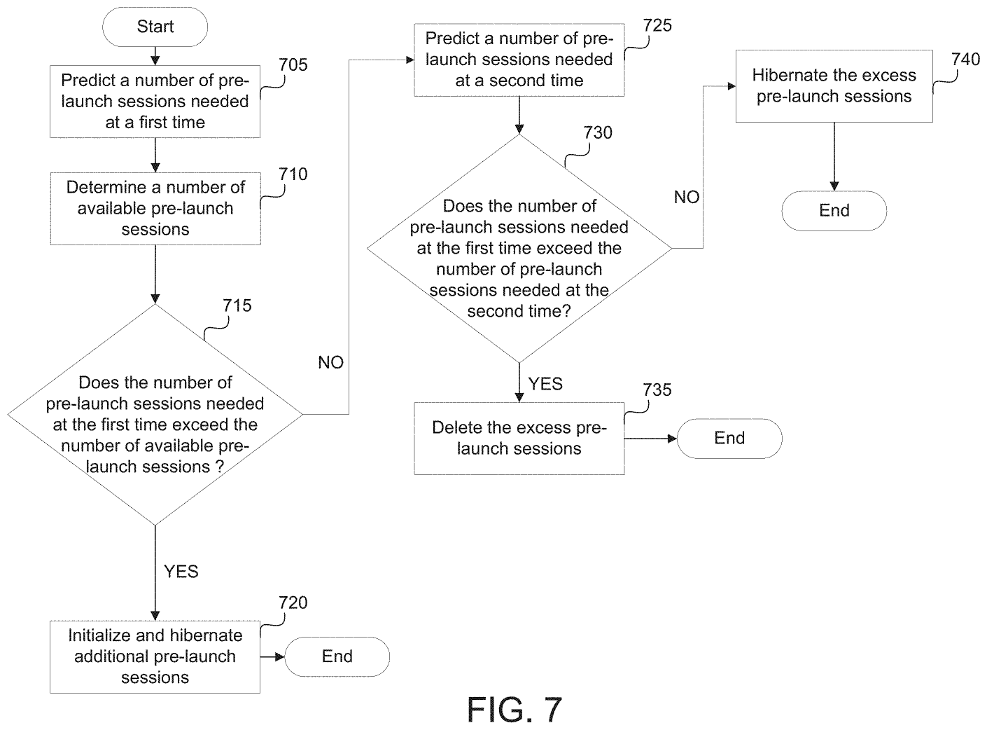

FIG. 9 illustrates example data that the pre-launch controller 650 may use to determine the number of available pre-launch sessions. As illustrated in FIG. 9, pre-launch controller 650 may determine that virtualization server 610 contains a total of four available virtual machine instances. Pre-launch controller 650 may determine that each available virtual machine instance contains nine available pre-launch sessions. As such, pre-launch controller 650 may determine that there may be a total number of 36 available pre-launch sessions.

At step 715, pre-launch controller 650 may compare the number of available pre-launch sessions, determined in step 710, to the predicted number of pre-launch sessions that may be needed at the first time, determined in step 705. Pre-launch controller 650 may determine that the predicted number of pre-launch sessions that may be needed at the first time exceeds the number of available pre-launch sessions. Alternatively, pre-launch controller 650 may determine that the number of available pre-launch sessions exceeds the number of pre-launch sessions that may be needed at the first time.

At step 720, pre-launch controller 650 may determine that the predicted number of pre-launch sessions that may be needed at the first time exceeds the number of available pre-launch sessions. Pre-launch controller 650 may determine that additional pre-launch sessions are necessary to satisfy the predicted number of pre-launch sessions that may be needed at the first time. To determine the number of additional pre-launch sessions that may be needed at the first time, pre-launch controller 650 may subtract the number of available pre-launch sessions from the predicted number of pre-launch sessions that may be needed at the first time. Pre-launch controller 650 may inform hibernation controller 660 that additional pre-launch sessions are needed to satisfy the predicted number of pre-launch sessions that may be needed at the first time. In particular, pre-launch controller 650 may transmit, to hibernation controller 660, the number of additional pre-launch sessions that are needed to satisfy the predicted number of pre-launch sessions that may be needed at the first time.

For example, pre-launch controller 650 may receive, from either session predictor 640 or prediction model 670, a prediction indicating that a total of 75 pre-launch sessions may be needed at 12:00 PM on Jan. 1, 2021. Pre-launch controller 650 may determine that virtualization server 610 contains 36 available pre-launch sessions. As such, pre-launch controller 650 may determine that 39 additional pre-launch sessions are necessary to satisfy the predicted number of pre-launch sessions that may be needed at 12:00 PM on Jan. 1, 2021. Pre-launch controller 650 may notify hibernation controller 660 that 39 additional pre-launch sessions are needed to match the predicted number of pre-launch sessions that may be needed at 12:00 PM on Jan. 1, 2021.

Hibernation controller 660 may receive, from pre-launch controller 650, an indication that additional pre-launch sessions are needed to match the predicted number of pre-launch sessions that may be needed at the first time. Hibernation controller 660 may generate additional virtual machine instances within virtualization server 610. Hibernation controller 660 may generate pre-launch sessions on each additional virtual machine instance to satisfy the predicted number of pre-launch sessions that may be needed at the first time. Hibernation controller 660 may hibernate the additional virtual machine instances and the additional pre-launch sessions using the hibernation process described in FIG. 6C.

For example, hibernation controller 660 may receive, from pre-launch controller 650, an indication that 39 additional pre-launch sessions are needed to match the predicted number of pre-launch sessions that may be needed at 12:00 PM on Jan. 1, 2021. Hibernation controller 660 may generate additional virtual machine instances within virtualization server 610 (e.g., five additional virtual machine instances). Hibernation controller 660 may populate the additional virtual machine instances with the 39 additional pre-launch sessions that are needed to match the predicted number of pre-launch sessions that may be needed at 12:00 PM on Jan. 1, 2021 (e.g., assign nine pre-launch sessions to each of the first four virtual machine instances and assign the three remaining pre-launch sessions to the fifth virtual machine instance). Hibernation controller 660 may store, in the RAM associated with each additional virtual machine instance (e.g., RAM 626), the data that may be used to present a virtual computing environment using each additional pre-launch session. Hibernation controller 660 may copy the data stored in the RAM associated with the additional virtual machine instance into the storage associated with the additional virtual machine instance (e.g., storage 625). Hibernation controller 660 may instruct the additional virtual machine instances to shutdown or “sleep” until the additional virtual machine instances are needed at 12:00 PM on Jan. 1, 2021. In doing so, hibernation controller 660 may instruct the additional pre-launch sessions on each additional virtual machine instance to shutdown or “sleep” until the additional pre-launch sessions are needed at 12:00 PM on Jan. 1, 2021.

Alternatively, at step 725, pre-launch controller 650 may determine that the number of available pre-launch sessions exceeds the predicted number of pre-launch sessions that may be needed at the first time. Pre-launch controller 650 may hibernate or delete a number of the available pre-launch sessions based on a second prediction from session predictor 640. As discussed in connection with step 705, session predictor 640 and prediction model 670 may use the prediction data, provided by virtualization server 610, to determine the number of pre-launch sessions that may be needed on the day indicated by virtualization server 610 and at a second time indicated by virtualization server 610. The prediction data may indicate historical usage data that session predictor 640 and prediction model 670 may use to predict the number of pre-launch sessions that may be needed. As illustrated in FIG. 8, the historical usage data may indicate the number of pre-launch sessions that were used on the same day and at the same time in recent weeks, months, years, or the like (e.g., the number of pre-launch session that were used on a particular date over the last three years, the number of pre-launch sessions that were used on a particular day during each month over the last year, and the like). For example, the historical usage data may indicate that, in recent years, the number of pre-launch sessions that were used at 2:00 PM on January 1 ranged from 45 to 50 pre-launch sessions.

The prediction data may further indicate historical prediction data that session predictor 640 and prediction model 670 may use to predict the number of pre-launch sessions that may be needed. As illustrated in FIG. 8, the historical prediction data may indicate the number of pre-launch sessions that were predicted for use on the same day and at the same time in recent weeks, months, years, or the like (e.g., the number of pre-launch sessions that were predicted for use on a particular date over the last five years, the number of pre-launch sessions that were predicted for use on a particular day during each month over the last six months, and the like). For example, the historical prediction data may indicate that, in recent years, the number of pre-launch sessions that were predicted for use at 2:00 PM on January 1 ranged from 46 to 50 pre-launch sessions.

Session predictor 640 and prediction model 670 may use the prediction data to determine the number of pre-launch sessions that may be needed at the second time. Session predictor 640 and prediction model 670 may compare the date and time for which a prediction is needed to the historical prediction data and the historical usage data. If the date and time for which a prediction is needed matches the data within the historical prediction data or the historical usage data, session predictor 640 and prediction model 670 may use the data within the historical prediction data and the historical usage data to inform the present prediction. For example, since the number of pre-launch sessions that were predicted for use at 2:00 PM on January 1 in recent years did not exceed 50 pre-launch sessions and since the number of pre-launch sessions used at 2:00 PM on January 1 in recent years did not exceed 50 pre-launch sessions, session predictor 640 and prediction model 670 may predict that, at most, 50 pre-launch sessions may be needed at 2:00 PM on Jan. 1, 2021.

Alternatively, if the date and time for which a prediction is needed do not match the data within the historical prediction data or the historical usage data, session predictor 640 and prediction model 670 may locate alternate data (e.g., a combination of the same date and a different time, a combination of a different date and the same time, or the like). For example, the historical prediction data and historical usage data might not contain the number of pre-launch sessions that were predicted for use and the number of pre-launch sessions that were used on January 1 at 2:00 PM. Consequently, session predictor 640 and prediction model 670 may determine whether the historical prediction data and the historical usage data contains data for either a different date and the same time (e.g., the first day of February at 2:00 PM, the first day of September at 2:00 PM, or the like), or for the same date and a different time (e.g., January 1 at 12:00 PM, January 1 at 3:30 PM, or the like). If session predictor 640 and prediction model 670 determine that the historical prediction data and historical usage data do not match the date and time for which a prediction may be needed, session predictor 640 and prediction model 670 may use the alternate data to inform the current prediction.

Session predictor 640 and prediction model 670 may transmit the second prediction to pre-launch controller 650. Prediction model 670 may store the second prediction within the historical prediction data. Prediction model 670 may use the updated historical prediction data when making future predictions.

At step 730, pre-launch controller 650 may compare the predicted number of pre-launch sessions that may be needed at the first time, determined in step 705, to the predicted number of pre-launch sessions that may be needed at the second time, determined in step 725. Pre-launch controller 650 may determine that the predicted number of pre-launch sessions that may be needed at the first time exceeds the predicted number of pre-launch sessions that may be needed at the second time. Pre-launch controller 650 may determine the difference between the predicted number of pre-launch sessions that may needed at the first time and the predicted number of pre-launch sessions that may be needed at the second time. Pre-launch controller 650 may instruct hibernation controller 660 to delete the excess pre-launch sessions that might not be needed at the second time. Alternatively, pre-launch controller 650 may determine that the predicted number of pre-launch sessions that may be needed at the second time exceeds the predicted number of pre-launch sessions that may be needed at the first time. Pre-launch controller 650 may determine the difference between the predicted number of pre-launch sessions that may needed at the second time and the predicted number of pre-launch sessions that may be needed at the first time. Pre-launch controller 650 may instruct hibernation controller 660 to hibernate the excess pre-launch sessions that might not be needed at the first time.

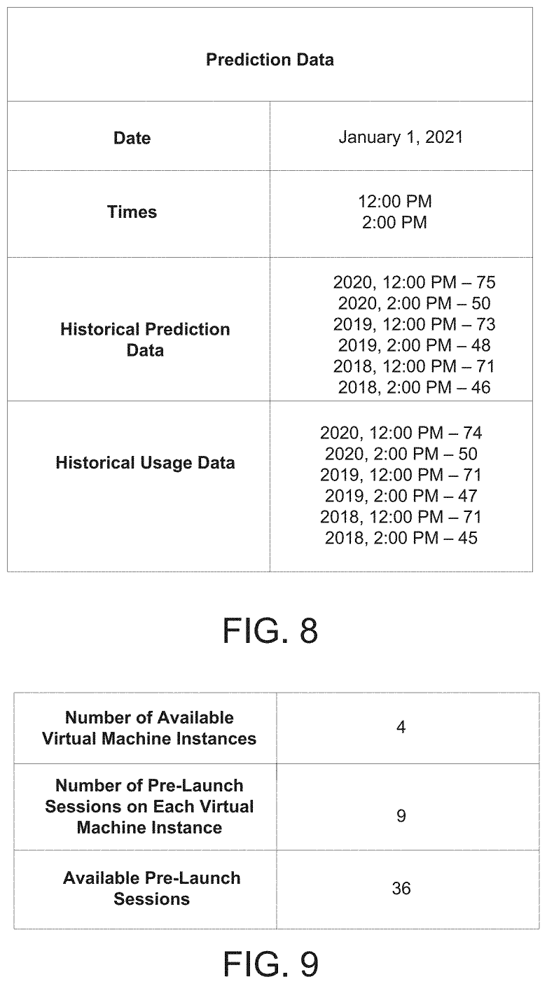

At step 735, pre-launch controller 650 may determine that the predicted number of pre-launch sessions needed at the first time exceeds the predicted number of pre-launch sessions needed at the second time. Pre-launch controller 650 may determine the difference between the predicted number of pre-launch sessions needed at the first time and the predicted number of pre-launch sessions needed at the second time. Based on the difference, pre-launch controller 650 may instruct hibernation controller 660 to delete the excess pre-launch sessions that might not be needed at the second time. In particular, pre-launch controller 650 may instruct hibernation controller 660 to delete the excess pre-launch sessions after the first time, but before the second time. FIG. 10 illustrates example deletion data that pre-launch controller 650 may use to determine the number of excess pre-launch sessions that might not be needed at the second time.

For example, as illustrated in FIG. 10, pre-launch controller 650 may determine that 75 pre-launch sessions are predicted for use at 12:00 PM on Jan. 1, 2021. Pre-launch controller 650 may determine that 50 pre-launch sessions are predicted for use at 2:00 PM on Jan. 1, 2021. Pre-launch controller 650 may determine that more pre-launch sessions are needed at 12:00 PM on Jan. 1, 2021 than at 2:00 PM on Jan. 1, 2021. In particular, pre-launch controller 650 may determine that 25 more pre-launch sessions are needed at 12:00 PM on Jan. 1, 2021 than at 2:00 PM on Jan. 1, 2021. Pre-launch controller 650 may instruct hibernation controller 660 to delete the 25 pre-launch sessions that might not be needed at 2:00 PM on Jan. 1, 2021. Pre-launch controller 650 may instruct hibernation controller 660 to delete the 25 pre-launch sessions after 12:00 PM, but before 2:00 PM on January 1, 2021. To delete the 25 pre-launch sessions that might not be needed at 2:00 PM on Jan. 1, 2021, hibernation controller 660 may locate the virtual machine instances, within virtualization server 610, that host the 25 pre-launch sessions. Hibernation controller 660 may delete the located virtual machine instances from virtualization server 610. By extension, hibernation controller 660 may delete, from virtualization server 610, the 25 pre-launch sessions that might not be needed at 2:00 PM on Jan. 1, 2021.

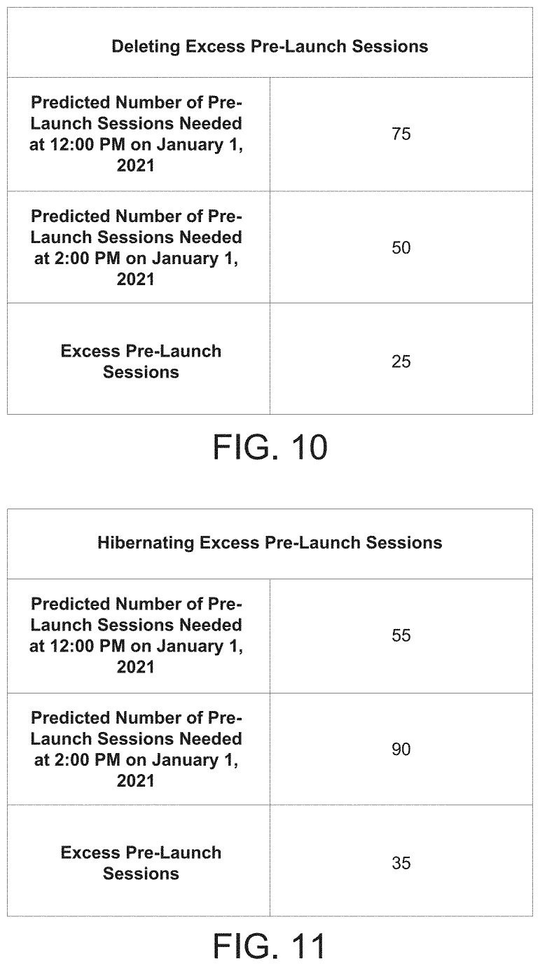

Alternatively, at step 740, pre-launch controller 650 may determine that the predicted number of pre-launch sessions needed at the second time exceeds the predicted number of pre-launch sessions needed at the first time. Pre-launch controller 650 may determine the difference between the predicted number of pre-launch sessions needed at the second time and the predicted number of pre-launch sessions needed at the first time. Based on the difference, pre-launch controller 650 may instruct hibernation controller 660 to hibernate the excess pre-launch sessions that might not be needed at the first time. In particular, pre-launch controller 650 may instruct hibernation controller 660 to hibernate the excess pre-launch sessions until the excess pre-launch sessions are needed at the second time. FIG. 11 illustrates example hibernation data that pre-launch controller 650 may use to determine the number of excess pre-launch sessions that might not be needed until the second time.

For example, as illustrated in FIG. 11, pre-launch controller 650 may determine that 55 pre-launch sessions are predicted for use at 12:00 PM on Jan. 1, 2021. Pre-launch controller 650 may determine that 90 pre-launch sessions are predicted for use at 2:00 PM on Jan. 1, 2021. Pre-launch controller 650 may determine that more pre-launch sessions are needed at 2:00 PM on Jan. 1, 2021 than at 12:00 PM on Jan. 1, 2021. In particular, pre-launch controller 650 may determine that 35 more pre-launch sessions are needed at 2:00 PM on Jan. 1, 2021 than at 12:00 PM on Jan. 1, 2021. Pre-launch controller 650 may instruct hibernation controller 660 to hibernate the 35 pre-launch sessions that might not be needed at 12:00 PM on Jan. 1, 2021. Pre-launch controller 650 may instruct hibernation controller 660 to hibernate the 35 pre-launch sessions until 2:00 PM on Jan. 1, 2021. To hibernate the 35 pre-launch sessions, hibernation controller 660 may locate the virtual machine instances, within virtualization server 610, that host the 35 pre-launch sessions. Hibernation controller 660 may initiate the hibernation process, illustrated in FIG. 6C, on the located virtual machine instances.

Hibernation controller 660 may store, in the RAM associated with each virtual machine instance that hosts the 35 pre-launch sessions (e.g., RAM 626), the data that may be used to present a virtual computing environment using each pre-launch session. Hibernation controller 660 may copy the data stored in the RAM associated with each virtual machine instance that hosts the 35 pre-launch sessions into the storage associated with each virtual machine instance that hosts the 35 pre-launch sessions (e.g., storage 625). Hibernation controller 660 may instruct each virtual machine instance that hosts the 35 pre-launch sessions to shutdown or “sleep” until each virtual machine instances is needed at 2:00 PM on Jan. 1, 2021. By extension, hibernation controller 660 may instruct the 35 pre-launch sessions to shutdown or “sleep” until the 35 pre-launch sessions are needed at 2:00 PM on Jan. 1, 2021.

The following paragraphs (M1) through (M20) describe examples of methods that may be implemented in accordance with the present disclosure.

(M1) A method comprising:

determining a number of available virtual machine instances, wherein each available virtual machine instance contains a number of available pre-launch sessions;

predicting a number of pre-launch sessions needed at a first time;

based on the number of pre-launch sessions needed at the first time exceeding the number of available pre-launch sessions, initializing additional pre-launch sessions; and

hibernating the additional pre-launch sessions until the first time.

(M2) A method may be performed as described in paragraph (M1), wherein the number of pre-launch sessions needed at the first time is based on historical data, wherein the historical data indicates a number of pre-launch sessions that were previously used at the first time.

(M3) A method may be performed as described in any of paragraphs (M1) through (M2) further comprising:

generating additional virtual machine instances, wherein the additional virtual machine instances contain the additional pre-launch sessions; and

hibernating the additional virtual machine instances until the first time.

(M4) A method may be performed as described in any of paragraphs (M1) through (M3) wherein the hibernating the additional virtual machine instances until the first time comprises:

moving the additional virtual machine instances from a running state to a stopped state; and

transferring processes from an additional virtual machine instance to storage associated with the additional virtual machine instance.

(M5) A method may be performed as described in any of paragraphs (M1) through (M4) further comprising resuming, at the first time, the additional virtual machine instances and the additional pre-launch sessions.

(M6) A method may be performed as described in any of paragraphs (M1) through (M5) further comprising hibernating an available virtual machine instance, wherein the hibernating the available virtual machine instance comprises:

predicting a number of pre-launch sessions needed at a second time;

determining a difference between the number of pre-launch sessions needed at the second time and the number of pre-launch sessions needed at the first time, wherein the difference indicates a number of pre-launch sessions to be hibernated; and

based on the difference, hibernating the number of pre-launch sessions to be hibernated.

(M7) A method may be performed as described in any of paragraphs (M1) through (M6) further comprising deleting an available virtual machine instance, wherein the deleting the available virtual machine instance comprises:

predicting a number of pre-launch sessions needed at a second time;

determining a difference between the number of pre-launch sessions needed at the first time and the number of pre-launch sessions needed at the second time, wherein the difference indicates a number of pre-launch sessions to be deleted; and

based on the difference, deleting the number of pre-launch sessions to be deleted.

(M8) A method comprising:

receiving, by a controller, a number of pre-launch sessions needed at a first time;

comparing, by the controller, the number of pre-launch sessions needed at the first time to a number of pre-launch sessions needed at a second time;

determining, by the controller, that the number of pre-launch sessions needed at the second time exceeds the number of pre-launch sessions needed at the first time; and

hibernating, by the controller, a portion of the number of pre-launch sessions needed at the second time.

(M9) A method may be performed as described in paragraph (M8), further comprising determining, by the controller, the number of pre-launch sessions needed at the first time based on historical data, wherein the historical data indicates a number of pre-launch sessions that were previously used at the first time.

(M10) A method may be performed as described in any of paragraphs (M8) through (M9), further comprising determining, by the controller, the number of pre-launch sessions needed at the second time based on historical data, wherein the historical data indicates a number of pre-launch sessions that were previously used at the second time.

(M11) A method may be performed as described in any of paragraphs (M8) through (M10), wherein the portion of the number of pre-launch sessions needed at the second time comprises a difference between the number of pre-launch sessions needed at the second time and the number of pre-launch sessions needed at the first time.

(M12) A method may be performed as described in any of paragraphs (M8) through (M11), further comprising generating, by the controller, virtual machine instances, wherein the virtual machine instances contain pre-launch sessions needed at the second time.

(M13) A method may be performed as described in any of paragraphs (M8) through (M12), wherein the hibernating comprises:

moving, by the controller, the virtual machine instances from a running state to a stopped state; and

transferring, by the controller, processes from a virtual machine instance to storage associated with the virtual machine instance.

(M14) A method may be performed as described in any of paragraphs (M8) through (M13), further comprising resuming, by the controller and at the second time, the portion of the number of pre-launch sessions needed at the second time.

(M15) A method comprising:

receiving, by a prediction model, input data indicating at least one date and at least one time for which a prediction of a number of pre-launch sessions is needed;

comparing, by the prediction model, the input to data indicating a number of pre-launch sessions that were previously predicted for use and to data indicating a number of pre-launch sessions that were previously used; and

based on the comparing, predicting the number of pre-launch sessions that are needed on a date and at a time indicated in the input data.

(M16) A method may be performed as described in paragraph (M15), wherein the predicting is further based on the input data matching the data indicating the number of pre-launch sessions that were previously predicted for use and the data indicating the number of pre-launch sessions that were previously used.

(M17) A method may be performed as described in any of paragraphs (M15) through (M16), further comprising determining that the input data does not match either one of the data indicating the number of pre-launch sessions that were previously predicted for use or the data indicating the number of pre-launch sessions that were previously used, and based on the determination:

predicting the number of pre-launch sessions that are needed on the date indicated in the input data, but at a second time different from the time indicated in the input data.

(M18) A method may be performed as described in any of paragraphs (M15) through (M17), further comprising determining that the input data does not match either one of the data indicating the number of pre-launch sessions that were previously predicted for use or the data indicating the number of pre-launch sessions that were previously used, and based on the determination:

predicting the number of pre-launch sessions that are needed at the time indicated in the input data, but on a second date that is different from the date indicated in the input data.

(M19) A method may be performed as described in any of paragraphs (M15) through (M18), further comprising storing, within the data indicating the number of pre-launch sessions that were previously predicted for use, a prediction indicating the number of pre-launch sessions that are needed on the date and at the time indicated in the input data.

(M20) A method may be performed as described in any of paragraphs (M15) through (M19), further comprising storing, within the data indicating the number of pre-launch sessions that were previously used, a number of pre-launch sessions that were used on the date and at the time indicated in the input data.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
determining a number of available virtual machine instances, wherein each available virtual machine instance contains a number of available pre-launch sessions;
predicting a number of pre-launch sessions needed at a first time;
based on the number of pre-launch sessions needed at the first time exceeding the number of available pre-launch sessions, initializing additional pre-launch sessions; and
hibernating the additional pre-launch sessions until the first time.

2. The method of claim 1, wherein the number of pre-launch sessions needed at the first time is based on historical data, wherein the historical data indicates a number of pre-launch sessions that were previously used at the first time.

3. The method of claim 1, further comprising:
generating additional virtual machine instances, wherein the additional virtual machine instances contain the additional pre-launch sessions; and
hibernating the additional virtual machine instances until the first time.

4. The method of claim 3, wherein the hibernating the additional virtual machine instances until the first time comprises:
moving the additional virtual machine instances from a running state to a stopped state; and
transferring processes from an additional virtual machine instance to storage associated with the additional virtual machine instance.

5. The method of claim 3, further comprising resuming, at the first time, the additional virtual machine instances and the additional pre-launch sessions.

6. The method of claim 1, further comprising hibernating an available virtual machine instance, wherein the hibernating the available virtual machine instance comprises:
predicting a number of pre-launch sessions needed at a second time;
determining a difference between the number of pre-launch sessions needed at the second time and the number of pre-launch sessions needed at the first time, wherein the difference indicates a number of pre-launch sessions to be hibernated; and
based on the difference, hibernating the number of pre-launch sessions to be hibernated.

7. The method of claim 1, further comprising deleting an available virtual machine instance, wherein the deleting the available virtual machine instance comprises:
predicting a number of pre-launch sessions needed at a second time;
determining a difference between the number of pre-launch sessions needed at the first time and the number of pre-launch sessions needed at the second time, wherein the difference indicates a number of pre-launch sessions to be deleted; and
based on the difference, deleting the number of pre-launch sessions to be deleted.

8. A method comprising:
receiving, by a controller, a number of pre-launch sessions needed at a first time;
comparing, by the controller, the number of pre-launch sessions needed at the first time to a number of pre-launch sessions needed at a second time;
determining, by the controller, that the number of pre-launch sessions needed at the second time exceeds the number of pre-launch sessions needed at the first time; and
hibernating, by the controller, a portion of the number of pre-launch sessions needed at the second time.

9. The method of claim 8, further comprising determining, by the controller, the number of pre-launch sessions needed at the first time based on historical data, wherein the historical data indicates a number of pre-launch sessions that were previously used at the first time.

10. The method of claim 8, further comprising determining, by the controller, the number of pre-launch sessions needed at the second time based on historical data, wherein the historical data indicates a number of pre-launch sessions that were previously used at the second time.

11. The method of claim 8, wherein the portion of the number of pre-launch sessions needed at the second time comprises a difference between the number of pre-launch sessions needed at the second time and the number of pre-launch sessions needed at the first time.

12. The method of claim 8, further comprising generating, by the controller, virtual machine instances, wherein the virtual machine instances contain pre-launch sessions needed at the second time.

13. The method of claim 12, wherein the hibernating comprises:
moving, by the controller, the virtual machine instances from a running state to a stopped state; and
transferring, by the controller, processes from a virtual machine instance to storage associated with the virtual machine instance.

14. The method of claim 13, further comprising resuming, by the controller and at the second time, the portion of the number of pre-launch sessions needed at the second time.

15. A method comprising:
receiving, by a prediction model, input data indicating at least one date and at least one time for which a prediction of a number of pre-launch sessions is needed;
comparing, by the prediction model, the input data to data indicating a number of pre-launch sessions that were previously predicted for use and to data indicating a number of pre-launch sessions that were previously used; and
based on the comparing, predicting the number of pre-launch sessions that are needed on a date and at a time indicated in the input data.

16. The method of claim 15, wherein the predicting is further based on the input data matching the data indicating the number of pre-launch sessions that were previously predicted for use and the data indicating the number of pre-launch sessions that were previously used.

17. The method of claim 15, further comprising determining that the input data does not match either one of the data indicating the number of pre-launch sessions that were previously predicted for use or the data indicating the number of pre-launch sessions that were previously used, and based on the determination:
predicting the number of pre-launch sessions that are needed on the date indicated in the input data, but at a second time that is different from the time indicated in the input data.

18. The method of claim 15, further comprising determining that the input data does not match either one of the data indicating the number of pre-launch sessions that were previously predicted for use or the data indicating the number of pre-launch sessions that were previously used, and based on the determination:
predicting the number of pre-launch sessions that are needed at the time indicated in the input data, but on a second date that is different from the date indicated in the input data.

19. The method of claim 15, further comprising storing, within the data indicating the number of pre-launch sessions that were previously predicted for use, a prediction indicating the number of pre-launch sessions that are needed on the date and at the time indicated in the input data.

20. The method of claim 15, further comprising storing, within the data indicating the number of pre-launch sessions that were previously used, a number of pre-launch sessions that were used on the date and at the time indicated in the input data.
